(19) United States
(12) Patent Application Publication
(10) Pub. No.: US 2005/0076843 A1
(43) Pub. Date: Apr. 14, 2005

(54) Collapsible game feeder

(76) Inventor: Albert A. Ansaldo, San Antonio, TX (US)

Correspondence Address: Thomas S. Birney, Esq.;Dorr, Carson, Sloan & Birney, P.C., 3010 East 6th Avenue, Denver, CO, 80206, US

(21) Appl. No.: 10/685,151

(22) Filed: Oct. 14, 2003

(51) Int. Cl. A01K 5/02

(52) U.S. Cl. 119/57.91

(57) ABSTRACT

A game feeder has a collapsible feed storage container supported by a detachable support structure to facilitate transportation in the field. A feed dispenser can be attached to the outlet of the feed storage container to dispense feed at selected times.

### BACKGROUND OF THE INVENTION

1. Field of the Invention. The present invention relates generally to the field of game feeders. More specifically, the present invention discloses a game feeder that can be readily assembled and disassembled for transportation in the field.

2. Statement of the Problem. Game feeders have been used for many years to dispense feed to game and livestock in the field. Many game feeders simply store and dispense feed at ground level. However, these types of feeders are subject to invasion by vermin and other pests. Other types of feeders can be suspended from trees to make the feed less accessible to unwanted animals. However, this requires a suitably sturdy tree at the desired location, and also typically requires that someone either climb the tree or use a ladder to suspend the feeder. Still other types of feeders are supported above the ground by a supported structure. However, these support structures tend to be rather large, bulky, and difficult to transport in the field, particularly if the desired location for the feeder is not readily accessible by motorized vehicle. Similarly, the feeder itself can also be large, bulky, and difficult to transport. Therefore, a need exists for a game feeder that is supported well above the ground, and that can be readily assembled and disassembled for transportation in the field.

3. Prior Art. The prior art in the field of feeders includes the following:

| Inventor | Pat. No. | Issue Date |
|---|---|---|
| Berghofer | 1,120,178 | Dec. 8, 1914 |
| Markey | 1,505,157 | Aug. 19, 1924 |
| Stonestreet et al. | 4,324,202 | Apr. 13, 1982 |
| King | 5,036,798 | Aug. 6, 1991 |
| Rasmussen | 5,259,337 | Nov. 9, 1993 |
| Vigesaa et al. | 5,275,129 | Jan. 4, 1994 |
| Rasmussen | 5,463,980 | Nov. 7, 1995 |
| Schulz | 5,794,561 | Aug. 18, 1998 |
| Kleinsasser | 5,850,805 | Dec. 22, 1998 |
| Sweeney | 5,862,777 | Jan. 26, 1999 |
| Kolbe | 6,053,124 | Apr. 25, 2000 |

Berghofer shows an example of a feeder having a “knock-down” construction that can be easily disassembled and reassembled. Stonestreet et al. and Rasmussen show other examples of the general concept of a knock-down feeder. The remaining patents disclose a wide variety of other types of feeders, but are only of general interest.

4. Solution to the Problem. None of the prior art references listed above have a collapsible feed storage box supported by a collapsible support frame. This enables feed to be stored at a considerable height above the ground. The feeder can also be readily disassembled into components that can be easily transported in the field and quickly assembled with only basic tools.

### SUMMARY OF THE INVENTION

This invention provides a game feeder having a collapsible feed storage container supported by a detachable support structure to facilitate transportation in the field. A feed dispenser can be attached to the outlet of the feed storage container to dispense feed at selected times.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a front perspective view of the game feeder 10.

FIG. 2 is an exploded perspective view of the feed storage container 20.

FIG. 3 is a vertical cross-sectional view of the feed storage container 20.

FIG. 4 is an exploded perspective view of the support structure 30.

### DETAILED DESCRIPTION OF THE INVENTION

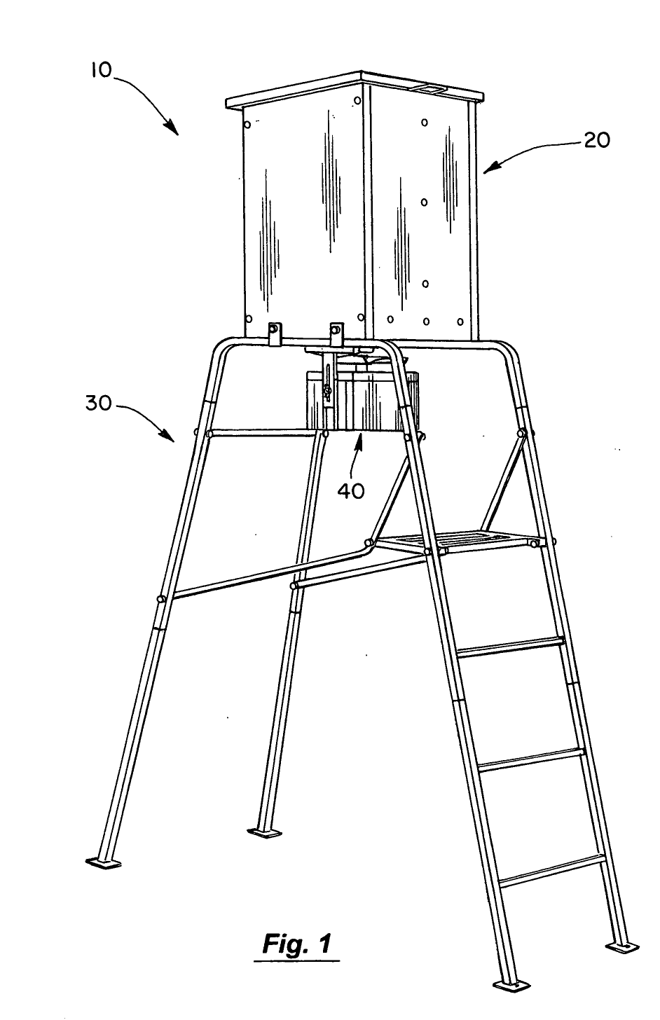

Turning to FIG. 1, a perspective view is provided showing the assembled game feeder 10. The major components of the feeder 10 are a feed storage container 20 and a support structure 30 that supports the feed storage container 20 above the ground. The support structure can be easily detached from the feed storage container 20, and both components are collapsible so that the feeder 10 can be readily transported in the field and assembled with basic tools and minimal effort.

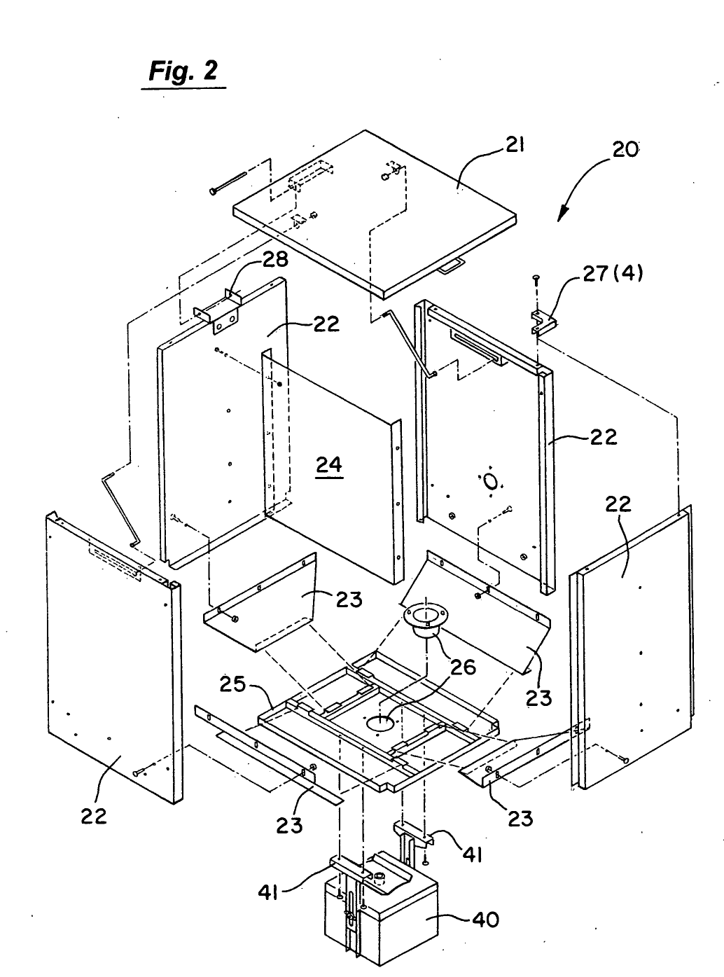

In particular, the feed storage container 20 is generally box-shaped in the preferred embodiment of the present invention. It has a series of side panels 22 that can fastened together with corner supports 27 to form an enclosure, as illustrated in the exploded view depicted in FIG. 2. The side panels 22 are fastened atop a bottom panel 25 to create a container capable of holding a quantity of animal feed. Optionally, the feed storage container can be equipped with a lid 21 to cover the upper opening of the container and protect the feed from weather and pests. In the preferred embodiment of the present invention, the lid 21 is mounted by hinges 28 to one of the side panels 22, so that the lid 21 can be lifted from the opposing edge to gain access to the interior of the feed storage container 20.

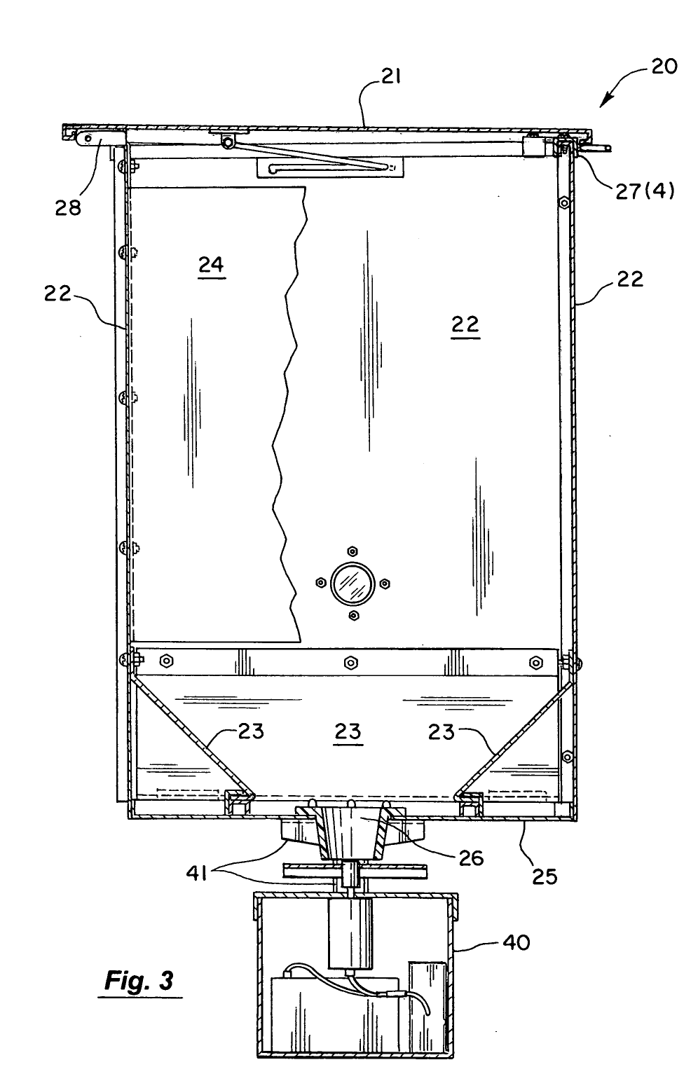

An outlet 26 in the bottom panel 25 allows feed to be withdrawn from the feed storage container 20. Optionally, a number of trough sides 23 can be placed inside the bottom portion of the feed storage container 20 to form a chute that funnels feed toward the outlet 26, as illustrated in the cross-sectional view of the feed storage container 20 illustrated in FIG. 3. One or more internal dividers 24 can also be inserted into the feed storage container 20 to subdivide its storage space. This can be used to enable several different feeds to be stored simultaneously and mixed as they are dispensed by the feed dispenser 40.

A battery-powered spreader box or a similar feed dispensing mechanism 40 can be attached to the bottom 25 of the feed storage container 20 below the outlet 26 by means of a series of brackets 41, as illustrated in FIGS. 2 and 3. For example, the feed dispenser 40 can be set to automatically dispense a quantity of feed onto the ground surrounding the feeder on a periodic basis.

It should be understood that the details of construction of the feed storage container 20 are largely a matter of design choice. The shape, size, number, and proportions of the panels and the types of fasteners used can be selected to meet the needs of the specific user. In the preferred embodiment of the feeder 10, all of the panels can be disassembled and stacked together in a compact group that can be easily transported in the field, and easily reassembled using only a screw driver.

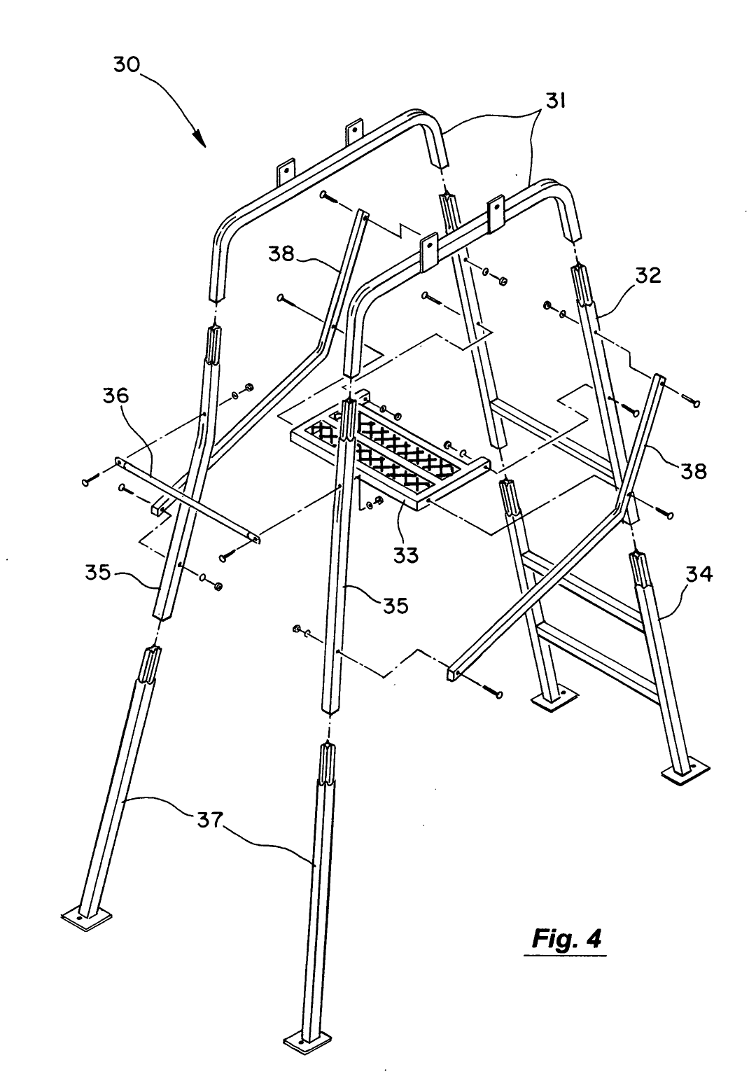

The support structure 30 is shown in greater detail in the exploded view shown in FIG. 4. The support structure includes a pair of feeder brackets 31 that removable attach to the feed storage container 20. A ladder extension 32 has a pair of vertical members that can be removably attached to the front of the feeder brackets 31 to form the front legs of the support structure 30. A foot platform 33 can be removably attached across the ladder extension 32 to serve as an elevated platform for the user to stand on while loading feed into the feed storage container 20. The ladder extension 32 can also be equipped with series of additional steps forming a ladder. In the embodiment shown in the drawings, the ladder portion of the assembly is further subdivided into a ladder base 34 that is removably attachable to the bottom of the ladder extension 32 to reduce the size of the components when disassembled.

The rear legs of the support structure 30 are formed by a set of leg extensions 35 that removably attach to the back of the feeder brackets 31, as shown in FIG. 4. Here again, the size of the disassembled components can be reduced by subdividing each rear leg into a leg base 37 that removably attaches to a leg extension 35.

Braces can be added to increase the stability and strength of the support structure 30. For example, a rear leg brace 36 can be removably secured between the rear leg extensions 35. Angle braces 38 can also be fastened between the rear legs and the ladder extension to support the rear edge of the foot platform 33.

To assemble the feeder support structure 30, the foot platform 33 is first fastened between the legs of the ladder extension 32 using bolts, screws, or the like. The upper ends of the legs of the ladder extension 32 are the inserted into the forward ends of the feeder brackets 31. Similarly, the rear leg extensions 35 are inserted into the rear ends of the feeder brackets 31. The rear leg brace 36 is then attached across the rear leg extensions 35. Angle braces 38 are fastened on each side of the support structure 30 between the rear leg extensions 35 and the ladder extensions 32 as shown in FIGS. 1 and 4. These angle braces are also attached to the rear portion of the foot platform 33 for additional support and rigidity. Finally, leg bases 37 are connected to the bottoms of the leg extensions 35, and the ladder base 34 is attached to the bottom of the ladder extension 32 to complete the support structure 30, which is now ready to accept the feed storage container 20.

The feed storage container 20 is assembled by fitting the side panels 22 together and securing them with the corner supports 27 and screws. The bottom panel 25 slides down through interior of the assembled side panels 22 to form the bottom of the feed storage container 20. The trough sides 23 are then inserted into the feed storage container and held in place by a tongue-and-groove attachment and screws. The internal divider 24 and lid hinge 28 can also be secured to the feed storage container 20 by screws, bolts, or the like. The lid 21 is then attached to the hinge 28. Optionally, a support arm can be secured to the lid 21 to support the lid 21 in an open position while loading feed into the feed storage container 20. Spreader brackets 41 are attached to the bottom 25 of the feed storage container 20 on either side of the outlet 26. The feed dispenser 40 is then inserted into the spreader brackets 41. Finally, the assembled feed storage container 20 is attached to the feeder brackets 31 of the support structure 30 by bolts, screws, or the like.

The above disclosure sets forth a number of embodiments of the present invention. Other arrangements or embodiments, not precisely set forth, could be practiced under the teachings of the present invention and as set forth in the following claims.

1. (canceled)

2. (canceled)

3. (canceled)

4. The game feeder of claim 7 wherein the feed storage container further comprises:
a plurality of detachable sides;
a bottom having an outlet; and
an internal trough directing feed within the feed storage container to the outlet.

5. The game feeder of claim 7 wherein the feed storage container further comprises a hinged lid.

6. (canceled)

7. A game feeder comprising:
a collapsible feed storage container having an outlet, formed from a plurality of panels that can be disassembled from one another;
a feed dispenser attachable at the outlet of the feed storage container; and
a support structure detachably supporting the feed storage container above the ground and having;
(a) a foot platform; and
(b) detachable legs.

8. The game feeder of claim 7 wherein the support structure further comprises a plurality of steps forming a ladder.

9. The game feeder of claim 7 further comprising removable trough panels forming a chute within the feed storage container to direct feed to the outlet.

10. A game feeder comprising:
a feed storage container having an outlet;
a feed dispenser attachable at the outlet of the feed storage container; and
a support structure detachably supporting the feed storage container above the ground and having;
(a) feeder brackets removably attachable to the feed storage container;
(b) a foot platform;
(c) a ladder extension removably attachable to the feeder brackets, supporting the foot platform and feed storage container; and
(d) at least one leg removably attachable to the feeder brackets and supporting the feed storage container.

11. The game feeder of claim 10 wherein the feed storage container further comprises:
a plurality of collapsible sides;
a bottom having an outlet; and
an internal trough directing feed within the feed storage container to the outlet.

12. The game feeder of claim 10 wherein the feed storage container further comprises a hinged lid.

13. The game feeder of claim 10 wherein the ladder extension further comprises a series of steps.

14. The game feeder of claim 10 further comprising a brace extending between a leg and the ladder extension to support the foot platform.

15. A game feeder comprising
a feed storage container having an outlet;
a feed dispenser attachable at the outlet of the feed storage container; and
a support structure detachably supporting the feed storage container above the ground and having;
(a) feeder brackets removably attachable to the feed storage container;
(b) a ladder extension removably attachable to the feeder brackets having a plurality of vertical members forming front legs and at least one step extending between the vertical members;
(c) a foot platform extending horizontally across the front legs above the steps; and
(d) a plurality of rear legs removably attachable to the feeder brackets.

16. The game feeder of claim 15 wherein the feed storage container further comprises:
a plurality of detachable sides;
a bottom having an outlet; and
an internal trough directing feed within the feed storage container to the outlet.

17. The game feeder of claim 15 wherein the feed storage container further comprises a hinged lid.

18. The game feeder of claim 15 further comprising removable trough panels forming a chute within the feed storage container to direct feed to the outlet.
